(19) United States
(12) Patent Application Publication
(10) Pub. No.: US 2023/0357470 A1
(43) Pub. Date: Nov. 9, 2023

(54) PHOTOCURABLE TOPCOAT REPAIR COMPOSITION AND METHOD FOR THE USE THEREOF

(71) Applicant: Illinois Tool Works Inc., Glenview, IL (US)

(72) Inventors: Robert Joseph Wehrle, Glenview, IL (US); Grant Shouldice, Glenview, IL (US)

(73) Assignee: Illinois Tool Works Inc., Glenview, IL (US)

(21) Appl. No.: 18/137,047

(22) Filed: Apr. 20, 2023

Related U.S. Application Data
(60) Provisional application No. 63/338,468, filed on May 5, 2022.

(51) Int. Cl. C08F 220/12; C09D 133/08; C09D 1/00

(52) U.S. Cl. CPC C08F 220/12; C09D 133/08; C09D 1/00

(57) ABSTRACT

A method for repairing a surface imperfection in a clear topcoat overlying a pigmented color coat of a panel includes the application of an amount of a repair composition to the surface imperfection in an amount to fill the surface imperfection. The repair composition is exposed to actinic radiation inducing cure of the repair composition to form a cured fill. A ceramic coating is readily applied after cure to overlie the fill with bonded ceramic particulate. A composition is also provided. An exterior body panel is also provided that includes a substrate having a shape of the panel. A pigmented color coat is present on a surface of the substrate. A clear topcoat overlies the pigmented color coat. A cured composition as detailed above fills surface imperfections in the topcoat.

### RELATED APPLICATIONS

This application claims priority benefit of U.S. Provisional Application Ser. No. 63/338,468 filed 5 May 2022; the contents of which are hereby incorporated by reference.

### FIELD OF THE INVENTION

The present invention in general relates to surface repairs and surface finishing for equipment and vehicles and in particular, to a system and process of paint correction after a resurfacing an exterior surface of the equipment or vehicle.

### BACKGROUND OF THE INVENTION

Traditionally, the automotive aftermarket has utilized well defined processes for the repair of vehicle and equipment exterior bodies. However, the method for repairing a damaged vehicle by painting is complicated and adds considerably to the time required for body repairs while increasing the costs of such repairs.

Pigmented base coatings and clear top coatings are conventionally applied to exterior surface substrates of vehicles to protect the substrates and provide a high gloss finish that serves both aerodynamic and aesthetic functions. A typical vehicle substrate has several coating layers that include a primer coat. A pigmented color coat is next applied over the primer. To protect the color coat, a transparent, unpigmented topcoat is often applied to protect the color coat from environmental exposure. Due to the environment contacting position, the topcoat is prone to scratching and spalling.

An exemplary body shop repair of such a surface imperfection, such as a scratch or shallow chip, begins with buffing to remove the appearance of the defect. This procedure often imparts swirl marks to the surface that are microbrasions when particulate of hard debris is carried by the buffing pad in a rotary fashion across the target surface. These micro-abrasion swirl patterns in turn require polishing prior to application of a ceramic coating composition that fills the crevices of the polished microabrasions and thereby resort the high gloss associated with a vehicle exterior or that of commercial equipment such as tractors, earth moving equipment, motorized agricultural vehicles, and the like. To further complicate the process, the ceramic coating composition often must be color matched so as to add to the equipment and effort of completing the repair. Addressing buffing inducing swirls and microabrasions is time-consuming process that limits the throughput of a repair shop. The cleanliness and cure conditions of elevated temperature for times that are too long that are required for application of such ceramic coating composition often means that such work is conducted under controlled conditions with failure to complete the application correctly leading to still more inefficiency to repeated application.

Thus, there exists a need for a chemistry and process of use thereof that overcomes the aforementioned limitations of the prior art by repairing topcoat surface imperfections.

### SUMMARY OF THE INVENTION

A method for repairing a surface imperfection in a clear topcoat overlying a pigmented color coat of a panel includes the application of an amount of a repair composition to the surface imperfection in an amount to fill the surface imperfection. The repair composition is exposed to actinic radiation inducing cure of the repair composition to form a cured fill. A ceramic coating is readily applied after cure to overlie the fill with bonded ceramic particulate.

A composition is also provided that includes photocurable monomer and photocurable oligomer. The photocurable monomer and photocurable oligomer together present in an amount of more than 50 total weight percent of the composition. A Norish type II photo-initiator is also present. A coupling agent is present from 5 to 22 total weight percent of the composition. The composition present in a resealable applicator able to apply the composition dropwise to a situs with a surface imperfection. Upon exposure to a suitable wavelength of ultraviolet light for activation of the photo-initiator, the composition cures to fill the surface imperfection to a self-leveled hardened mass.

An exterior body panel is also provided that includes a substrate having a shape of the panel. A pigmented color coat is present on a surface of the substrate. A clear topcoat overlies the pigmented color coat. A cured composition as detailed above fills surface imperfections in the topcoat.

### DETAILED DESCRIPTION OF THE PREFERRED EMBODIMENTS

The present invention has utility of correcting imperfections in a clear topcoat overlying a pigmented color coat without damage to the pigmented color coat that is all too common with conventional techniques. While the present invention will be further detailed with respect a high gloss vehicle exterior surface, it is appreciated that the present is equally applicable to commercial equipment, agricultural equipment, and kitchen appliances. With the use of this system, surface imperfections such as rotary buffer induced swirl marks are corrected quicker than by conventional techniques. Furthermore, in those instances when the surface imperfect is limited in depth relative to the pigmented color coat, an inventive composition is applied in lieu of a conventional mechanical buffing process.

Absent UV exposure, an inventive composition has a working time that is theoretically completely open yet cures rapidly upon UV exposure thereby offering a user a controlled working time and a rapid cure thereafter.

Numerical ranges cited herein are intended to recite not only the end values of such ranges but the individual values encompassed within the range and varying in single units of the last significant figure. By way of example, a range of from 0.1 to 1.0 in arbitrary units according to the present invention also encompasses 0.2, 0.3, 0.4, 0.5, 0.6, 0.7, 0.8, and 0.9; each independently as lower and upper bounding values for the range.

Table 1 lists the major components of an embodiment of the inventive surface imperfection filling composition.

TABLE 1
Formulation of a UV curable surface
imperfection repair composition

| | Typical Total | Preferred Total |
|---|---|---|
| Ingredient | Weight Percent | Weight Percent |
| Photocurable monomer | Remainder | Remainder |
| Photocurable oligomer | 20-76 | 24-54 |
| Solvent | 0-50 | 0-50 |
| Norish type I or II | 0.5-5 | 1-2 |
| photo-initiator(s) | | |
| Cure promoter | 0-5 | 0.5-2 |
| Coupling agent | 5-22 | 6-12 |
| Additives | Each: 0-5 | 1-3 |
| Filler | 0-25 | 0-12 |

A photocurable monomer is present in an inventive composition that is multifunctional. As used herein, multifunctional is defined as a compound that has a polymerizable functionality of at least 2. Difunctional photocurable monomers are particularly well suited for use in the present invention. Photocurable monomers operative in the present invention illustratively include diallyl fumarate, diallyl diglycol carbonate, allyl methacrylate, isobornyl acrylate, diallyl phthalate, diallyl suberate, diallyl tetrabromophthalate, diethylene glycol diacrylate, diethylene glycol dimethacrylate, diethylene glycol divinyl ether, N,N′-dinethacryloylpiperazine, 2,2-dimethylpropanediol dimethacrylate, dipentaerythritol pentaacrylate, dipropylene glycol dimethacrylate, di-trimethylolpropane tetraacrylate, divinyl glycol, divinyl sebacate, glycerol trimethacrylate, 1,5-hexadiene, 1,6-hexanediol diacrylate, 1,6-hexanediol dimethacrylate, N,N′-methylenebismethacrylamide, 1,9-nonanediol dimethacrylate, pentaerythritol tetraacrylate, pentaerythrtol triacrylate, pentaerythritol triallyl ether, 1,5-pentanediol dimethacrylate, poly(propylene glycol) dimethacrylate, tetraethylene glycol dimethacrylate, triethylene glycol diacrylate, triethylene glycol dimethacrylate, dipropylene glycol diacrylate, triethylene glycol divinyl ether, 1,1,1-trimethylolethane trimethacrylate, 1,1,1-trimethylolpropane diallyl ether, 1,1,1-trimethylolpropane triacrylate, 1,1,1-trimethylolpropane trimethacrylate, tripropylene glycol diacrylate, 1,2,4-trivinylcyclohexane, divinyl benzene, bis(2-methacryloxyethyl)phosphate, 2,2-bis(4-methacryloxyphenyl)propane, 1,3-butanediol diacrylate, 1,4-butanediol diacrylate, 1,3-butanediol dimethacrylate, 1,4-butanediol dimethacrylate, 1,4-butanediol divinyl ether, 1,4-cyclohexanediol dimethacrylate, bis[4-(vinyloxy)butyl]isophthalate, bis[4-(vinyloxymethyl)cyclohexylmethyl]glutarate, bis[4-(vinyloxy)butyl]succinate, bis((4-((-vinyloxy)methyl)cyclohexyl)methyl)isophthalate, bis(4-(vinyloxy)butyl)terephthalate, bis[[(4-[vinyloxy)methyl)cyclohexyl]methyl]terephthalate, bis[4-vinyloxy)butyl]adipate, bis[4-(vinyloxy)butyl](methylenedi-1,4-phenylene)biscarbamate, bis-[4-(vinyloxy)butyl](4-methyl-1,3-phenylene)biscarbamate, bis[4-(vinyloxy)butyl]1,6-hexanediylbiscarbamate, tris[4-(vinyloxy)butyl]trimellitate or combinations thereof. It is appreciated that a minority amount of trifunctional or higher functional photocurable monomer modifies the cured coating properties to form a more rigid cured fill. A more rigid fill is often beneficial when a large area or entire panel are corrected herewith.

A photocurable oligomer is present in an inventive composition that is multifunctional in terms of carbon-carbon bond unsaturation. A photocurable oligomer having four or more functional groups is particularly suitable to facilitate the rapid cure rates for surface imperfection repair and impart hardness the cured fill. Photocurable oligomers operative herein illustratively include a polyurethane tetraacrylate, a polyurethane tetramethacrylate, polyurethane pentaacrylate, polyurethane penta methacrylate, polyurethane hexaacrylate, polyurethane hexamethacrylate, polyether tetraacrylate, polyether tetramethacrylate, polyether pentaacrylate, polyether pentamethacrylate, polyether hexaacrylate, polyether hexamethacrylate, polyester tetraacrylate, polyester tetramethacrylate, polyester penta methacrylate, polyester hexaacrylate, polyester hexamethacrylate, polysiloxane diacrylate, polysiloxane triacrylate, polysiloxane tetraacrylate, polysiloxane pentaacrylate, polysiloxane hexaacrylate, or combinations thereof.

In order to achieve actinic cure, a Norish type II photo-initiator is present from 0.5 to 5 total weight percent. It is appreciated that a Norish type I photo-initiator is also operative herein with the proviso that a solvent is also present and able to afford some actinic attenuation. It is further appreciated that retention in an opaque container promotes storage stability. It has been surprisingly found that this subset of photo-initiators affords rapid cure upon exposure to a suitable initiation ultraviolet wavelength while providing storage stability of the composition in an opaque, applicator for at least one month at 20 degrees Celsius; the applicator chemically compatible with the composition. Norish type II photo-initiators are characterized by radical formation occurring through hydrogen abstraction, and those operative herein include benzophenone derivative having the general formula (I):

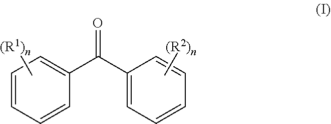

where R¹ and R² are each independently of each other C₁-C₆ alkyl, n is independently in each occurrence 0, 1, 2 or 3. Without intending to be bound to a particular theory, a compound of formula (I) generates a radical active in resin and monomer cure as follows:

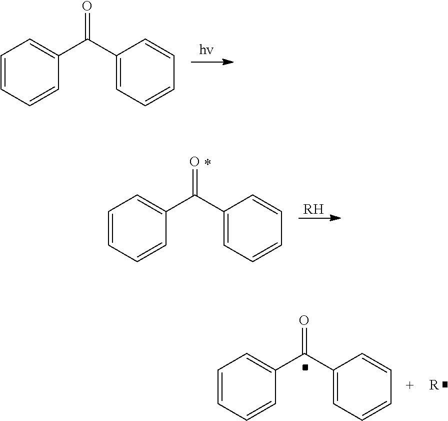

Additional Norish Type II photoinitiators are described in Chemistry & Technology of UV & EB Formulation for Coatings, Inks & Paints, Vol. 2, 1991, SITA Technology, London (P. K. T. Oldring (Ed.) On pages 288 to 294.) In addition to benzophenone derivatives, thioxanthone and 1,2-diketone derivatives also belong to this class of compounds. In some inventive embodiments, 0.1 to 2 total weight percent of acylphosphine oxide derivatives or α-aminoalkylphenone derivatives are also present as part of the total amount of Norish type II photo-initiator.

It is appreciated that photo-initiators have strong light absorption in the wavelength range of 250 nm to 420 nm. Inventive compositions containing photo-initiators are readily cured with mercury vapor arc lamps, UV-A emitting light emitting diodes (LEDs), as well as sunlight. With resort to lamps and LEDs, cure times are readily adjusted to be in the range of 1 to 10 minutes. As a result, the repair is efficiently completed and less prone to dust collection in the repaired fill.

A cure promoter is present from 0.05 to 5 total weight percent. In the reaction, the cure promoter, donates free hydrogen and can also consume a certain amount of oxygen to prevent oxygen quenching effect on photo-initiator under cure conditions. Cure promoters operative herein include tertiary amines, beta-ketoamines, methylene groups adjacent to oxygen of an epoxide group, and polyethers, the aforementioned miscible and compatible with the crosslinking agent. Specific chemical initiators operative herein include N,N-Bis(2-hydroxyethyl)-p-toluidine, 2-ethylhexyl-4-dimethylaminobenzoate, ethyl-4-dimethylaminobenzoate, 3,3′-dimethyl-methylene-di(cyclohexylamine), Lasalocid A; and combinations thereof.

A coupling agent is present to promote adhesion to the underlying layers of the surface imperfection namely the topcoat alone, or the topcoat and underlying pigmented color coat; as well as enhanced bonding to an overlying ceramic coating. Coupling agents operative herein illustratively include 3-aminopropyltrimethoxysilane, 3-aminopropyltriethoxysilane, 3-glycidoxypropyltrimethoxysilane, 3-glycidoxypropyltriethoxysilane, (3-glycidoxypropyl) bis(trimethylsiloxy)methylsilane, (3-glycidoxypropyl)methyldiethoxysilane, (3-glycidoxypropyl) dimethylethoxysilane, 3-(mercaptopropyl)triethoxysilane, (3-glycidoxypropyl)methyldimethoxysilane, methacryloxymethyltriethoxysilane, methacryloxymethyltrimethoxysilane, methacryloxypropyldimethylethoxysilane, methacryloxypropyldimethylmethoxysilane, ethacryloxypropylmethyldimethoxysilane, methacryloxypropyltriethoxysilane, methoxymethyltrimethylsilane, 3-methoxypropyltrimethoxysilane, 3-methacryloxypropyldimethylchlorosilane, methacryloxypropylmethyldichlorosilane, methacryloxypropyltrichlorosilane, 3-isocyanatopropyldimethylchlorosilane, 3-isocyanatopropyltriethoxysilane, bis(3-triethoxysilylpropyl)tetrasulfide, and combinations thereof.

Several additives are readily included in an inventive formulation that illustratively include light and heat stabilizers to maintain clarity of the cured fill, adhesion promoters, flow control additives, pigments and dyes and combinations thereof. Generally, each of the aforementioned additives is independently present from 0 to 5 total weight percent.

While fillers are typically unnecessary in an inventive repair composition owing to the small dimensions of the microbrasions and surface imperfections being corrected, such fillers are optionally present to afford impart hardness and visual effects. It is appreciated that the inclusion of fillers is particularly advantageous if a ceramic overcoat is not used to protect the UV cured fill. Filler particulates operative in the present invention illustratively include mica flakes, talc, alumina, silica, titania, calcium microspheroids, and combinations thereof. Generally, particulate is present from 0 to 4 total weight percent.

An inventive repair composition typically has a fully formulated viscosity in the range of from 100 to 1,000 cps at 20° C. and is flowable prior to said exposing to actinic radiation. It is appreciated that a substrate in need of repair is often mounted vertically or even inverted such as while the repair composition should flow to fill surface imperfections, the composition should also have sufficient viscosity as to not excessively run form a vertical or inverted substrate. An attribute of the present invention in some embodiments is that the composition self-levels to fill a surface imperfection. In still other embodiments, the composition also does run excessively prior to cure. It is appreciated that in some instances of usage, one of skill in the art will resort to a temporary dam around a surface imperfection to facilitate fill thereof without excessive overburden beyond confines of the dam or an applicator/rag in which the compound should wick into the defect via capillary action.

The composition present in a resealable applicator able to apply the composition dropwise to a situs with a surface imperfection. Upon exposure to a suitable wavelength of ultraviolet light for activation of the photo-initiator, the composition cures to fill the surface imperfection to a self-leveled hardened mass.

In usage, a surface imperfection is in a clear topcoat overlying a pigmented color coat of a panel is repaired by applying an amount of a repair composition to the surface imperfection in an amount to fill the surface imperfection. In some instances excess is removed, or the amount otherwise adjusted to fill the imperfection or even overfill to a create an overburden of the composition. The overburden can extend from a millimeter to wholly coating a surface of the panel. Once the repair composition is in place and excess liquid removed or a dam is created to limit repair composition spread, the repair composition is exposed to actinic radiation to induce cure thereof. It is appreciated that this process is repeated if needed to build still further thickness of the resulting fill of cured repair composition.

The cured repair composition fill is rendered more durable through overcoating same with a ceramic coating. Without intending to be bound to a particular theory the coupling agent facilitates adhesive of ceramic particulate in a ceramic coating thereby retaining the ceramic overcoating of particulate for months and even years. A typical lifetime of such a ceramic coating on a vehicle hood is from 12 to 24 months. Ceramics particulates operative herein include silica, rare earths, metal elements, and the oxides, carbides, nitrides, borides, silicides, silicates, and sulfides of metal elements; graphene; and combinations thereof. These ceramic particulates are routinely formulated with various surfactants, resins, and polymers to form aqueous dispersions. Any number of conventional and commercially available ceramic coating compositions are operative herein and include Shine Armor Fortify Quick Coat, Turtle Wax Hybrid Ceramic Wax, Mothers Ceramic Spray (CMX), Nextgen Ceramic Spray, Ethos Resist Graphene Hybrid Coating; as well as that detailed in co-pending U.S. Patent Application 63/255,073, the contents of which are hereby incorporated by reference.

### EXAMPLES

These examples demonstrate the processes to be claimed in this patent filing. It should be remarked that other additions and modifications as known in the art are also expected to be covered.

### Example 1

An inventive composition is provided based on photocurable monomers of hexanediol diacrylate, dipropylene glycol diacrylate, and trimethylolpropane triacrylate (in equal amounts and at 50 total weight percent), polyester tetraacrylate (40 total weight percent), 3-(mercaptopropyl)triethoxysilane (8 total weight percent), a Norish type II photoinitiator of 4,4′-dimethylbenzophenone (2 total weight percent). The inventive composition is applied to a buffer created swirl in a vehicle hood and after exposure to actinic radiation from a UV-LED at 270 nm for 3 minutes, the applied layer cures to create a visually intact clear topcoat to an unaided normal human eye under daylight conditions.

### Example 2

The process of Example 1 is repeated with the with 6 total weight percent mica in place of a like amount of photocurable monomers. A similar cure profile results.

### Example 3

The process of Example 1 is repeated with the with 6 total weight percent pumice (3 micron diameter) in place of a like amount of photocurable monomers. A similar cure profile results.

### Example 4

The process of Example 1 is repeated with a dam around the target swirls. A similar cure profile results.

### Example 5

The process of Example 1 is repeated with a spray layer of SiCl₄ derived ceramic applied thereover. The resulting panel had a gloss comparable to a new panel and retained the appear for more than 3 months.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A method for repairing a surface imperfection in a clear topcoat overlying a pigmented color coat of a panel comprising:
applying an amount of a repair composition to the surface imperfection in an amount to fill the surface imperfection;
exposing said repair composition to actinic radiation inducing cure of said repair composition to form a cured fill.

2. The method of claim 1 wherein actinic radiation is sunlight.

3. The method of claim 1 wherein actinic radiation is a lamp emitting ultraviolet radiation.

4. The method of claim 3 wherein exposing occurs for an amount of time from 1 to 10 minutes.

5. The method of claim 1 further comprising leveling said repair composition to fill or slightly overfill the surface imperfection prior to said exposing.

6. The method of claim 1 wherein said repair composition has a viscosity in the range of from 100 to 1,000 cps at 20° C. and is flowable prior to said exposing.

7. The method of claim 1 further comprising applying said repair composition to a complete surface of the panel containing the surface imperfection prior to said exposing.

8. The method of claim 1 further comprising forming a dam around said repair composition prior to said exposing.

9. The method of claim 1 further comprising using a applicator/rag from which said repair composition wicks into the defect via capillary action to prior to said exposing.

10. The method of claim 1 further comprising applying a ceramic coating to said cured fill.

11. The method of claim 10 wherein said ceramic coating comprises silica particulate.

12. A surface repair composition comprising:
photocurable monomer;
photocurable oligomer, said photocurable monomer and said photocurable oligomer present in an amount of 40 or more total weight percent of the composition;
a Norish type I or type II photo-initiator; a solvent present in an amount between 0 and 50 weight percent of the composition; and
a coupling agent present from 5 to 22 total weight percent of the composition; the composition present in a resealable applicator able to apply the composition dropwise.

13. The composition of claim 12 further comprising a cure promoter.

14. The composition of claim 12 further comprising at least additive of a light stabilizer, a heat stabilizer, an adhesion promoter, a flow control additive, a pigment, a dye, or a combination thereof.

15. The composition of claim 12 further comprising a particulate filler.

16. The composition of claim 12 further comprising at least one of an acylphosphine oxide derivative or an α-aminoalkylphenone derivative.

17. An exterior body panel comprising:
a substrate having a shape of the panel;
a pigmented color coat on a surface of the substrate;
a clear topcoat overlying said pigmented color coat; and
a cured composition of claim 1.

18. The panel of claim 17 further comprising a ceramic coating overlying said cured composition.
